(19) United States
(12) Patent Application Publication
(10) Pub. No.: US 2008/0018482 A1
(43) Pub. Date: Jan. 24, 2008

(54) TEMPERATURE SENSING APPARATUS UTILIZING BIPOLAR JUNCTION TRANSISTOR, AND RELATED METHOD

(76) Inventors: Chi-Kun Chiu, Tao-Yuan Hsien (TW); Chih-Chun Tang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/456,853

(22) Filed: Jul. 11, 2006

(51) Int. Cl. G08B 17/00

(52) U.S. Cl. 340/584

(57) ABSTRACT

A temperature sensing apparatus for generating a sensing signal for indicating whether the temperature is higher or lower than a first threshold includes a bipolar junction transistor and a resistor. The bipolar junction transistor has a base terminal receiving a first constant voltage, an emitter terminal receiving a second constant voltage, and a collector terminal connecting to a node. The resistor is coupled between the node and a supply voltage. The first threshold is a value corresponding to the difference between the first and second constant voltages. The signal at the node is outputted to generate the sensing signal, which indicates the temperature is higher than the first threshold if the sensing signal is lower than a second threshold, and indicates the temperature is lower than the first threshold if the sensing signal is higher than the second threshold.

### BACKGROUND

A common practice to realize the implementation of an electronic system having certain desired characteristics is to assemble various discrete components. The components may include semiconductors and the like. Each of the components has a specific functionality required for the electronic device. However, it is often the situation that ultimately the assemblage of such various discrete components fails to provide some desired functionality under certain conditions.

For example, some of the components pose a variety of problems, such as components that lose their anticipated characteristics at a lower temperature or a higher temperature or both, even though such components exhibit their anticipated characteristics at room temperature. Conventionally, when such a problem arises, a different semiconductor circuit must be sought or the function block associated with the semiconductor must be modified to circumvent the problem. In cases where a solution for such a problem is not found then, a compromise is made to limit the use range of the electronic device. It is obvious, however, that these measures are not true solutions to the problem.

Please refer to FIG. 1 that illustrates a temperature compensation circuit 100 according to the related art. A bipolar junction transistor 120 of the NPN type is utilized as the main device to realize the temperature compensation circuit 100. The bipolar junction transistor 120 has a base terminal connected to a variable dc voltage source 110 whose voltage is adjustable to provide a proper voltage V_{B1}. The collector terminal is connected to a voltage source, and the emitter terminal is coupled to ground via a resistor R_{c}. In the temperature compensation circuit 100 thus configured, the output terminal Vₒ is supplied with the voltage V_{B1} via two different paths: one path through the first resistor Rₐ and the other path through the emitter terminal of the bipolar junction transistor 120 and the resistor R_{b}.

The voltage difference V_{BE1} across the base-emitter junction amounts to the forward voltage of a ‘diode’, which has, in the example shown herein, a negative temperature coefficient of about −1.5 mV/K. On the other hand, the voltage supplied to the output terminal Vₒ through the second path is the sum of the base-emitter voltage V_{BE1} of the bipolar junction transistor 120 and the voltage across the second resistor R_{b}. These voltages depend on the respective temperature characteristics of the base-emitter junction and the resistor R_{b}. Thus, the voltage at the output terminal is given by

$${V}_{o} = {V}_{B 1} - \frac{{R}_{a}}{{R}_{a} + {R}_{b}} \times {V}_{BE 1} . \qquad ( 1 )$$

It is seen that the base-emitter voltage V_{BE1} has a negative coefficient −Rₐ/(Rₐ+R_{b}), which is constant at all temperatures provided that the resistances Rₐ and R_{b} are constant. The output voltage Vₒ may be changed by varying the resistances Rₐ and R_{b}. In this manner, it is possible to generate an output voltage Vₒ that possesses a temperature characteristic for compensating an electronic device. In such a case shown in FIG. 1, the output voltage Vₒ will have a positive temperature coefficient under the assumption that the voltage V_{B1} is temperature independent.

According to equation (1), it is obvious that the output voltage Vₒ at the output node changes continuously along with changes in the temperature. Although the output voltage has a temperature dependent characteristic, it does not directly indicate whether the temperature has or has not exceeded a temperature threshold.

### SUMMARY

One objective of the claimed invention is therefore to provide a temperature sensing apparatus and the related methods to solve the problems mentioned above.

According to an embodiment of the claimed invention, a temperature sensing apparatus is disclosed. The temperature sensing apparatus is utilized for generating a sensing signal for indicating whether the temperature is higher or lower than a first threshold. The temperature sensing apparatus comprises a bipolar junction transistor and a resistor. The bipolar junction transistor has a base terminal receiving a first constant voltage, an emitter terminal receiving a second constant voltage, and a collector terminal connecting to a node, where the second constant voltage is temperature-independent, and the first constant voltage is higher than the second constant voltage. The resistor is coupled between the node and a supply voltage. The first threshold is a value corresponding to the difference between the first and second constant voltages. The signal at the node is outputted to generate the sensing signal, which indicates the temperature is higher than the first threshold if the sensing signal is lower than a second threshold voltage, and indicates the temperature is lower than the first threshold if the sensing signal is higher than the second threshold voltage.

According to another embodiment of the claimed invention, a temperature sensing apparatus is further disclosed. The temperature sensing apparatus is utilized for generating a sensing signal for indicating whether the temperature is higher or lower than a first threshold. The temperature sensing apparatus comprises a bipolar junction transistor and a resistor. The bipolar junction transistor has a base terminal receiving a first constant voltage, an emitter terminal receiving a second constant voltage, and a collector terminal connecting to a node, where the second constant voltage is temperature-independent, and the second constant voltage is higher than the first constant voltage. The resistor is coupled between the node and a third constant voltage. The first threshold is a value corresponding to the difference between the first constant voltage and the second constant voltage. The signal at the node is outputted to generate the sensing signal, which indicates the temperature is higher than the first threshold if the sensing signal is higher than a second threshold voltage, and indicates the temperature is lower than the first threshold if the sensing signal is lower than the second threshold voltage.

Accordingly, a method for generating a sensing signal for indicating whether the temperature is higher or lower than a first threshold is disclosed. The method comprises providing a bipolar junction transistor having a base terminal receiving a first constant voltage, an emitter terminal receiving a second constant voltage, and a collector terminal connecting to a node, and providing a resistor coupled between the node and a supply voltage. The second constant voltage is temperature-independent, and the first constant voltage is higher than the second constant voltage. The first threshold is a value corresponding to the difference between the first and second constant voltages. The signal at the node is outputted to generate the sensing signal, which indicates the temperature is higher than the first threshold if the sensing signal is lower than a second threshold voltage, and indicates the temperature is lower than the first threshold if the sensing signal is higher than the second threshold voltage.

Accordingly, a method for generating a sensing signal for indicating whether the temperature is higher or lower than a first threshold is further disclosed. The method comprises providing a bipolar junction transistor having a base terminal receiving a first constant voltage, an emitter terminal receiving a second constant voltage, and a collector terminal connecting to a node, and providing a resistor coupled between the node and a third constant voltage. The second constant voltage is temperature-independent, and the second constant voltage is higher than the first constant voltage. The first threshold is a value corresponding to the difference between the first constant voltage and the second constant voltage. The signal at the node is outputted to generate the sensing signal, which indicates the temperature is higher than the first threshold if the sensing signal is higher than a second threshold voltage, and indicates the temperature is lower than the first threshold if the sensing signal is lower than the second threshold voltage.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a related art temperature compensation circuit.

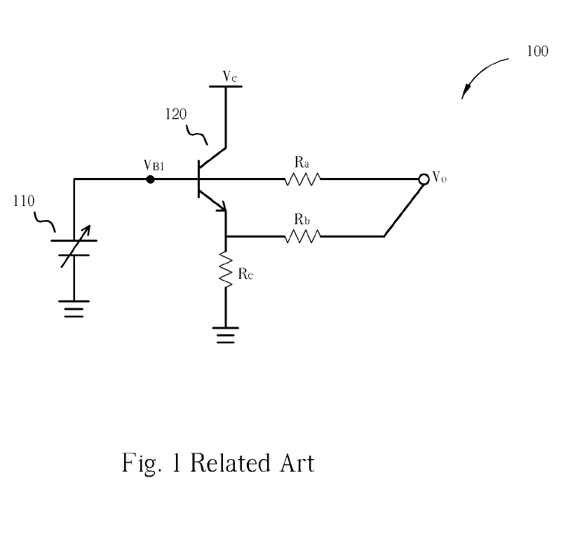

FIG. 2 shows a temperature sensing apparatus according to a first embodiment of the present invention.

FIG. 3 is a plot of the base-to-emitter turn on voltage V_{BE(on)} of a bipolar junction transistor with respect to the temperature (° C.).

FIG. 4 shows the inner circuitry of the buffer shown in FIG. 2.

FIG. 5 shows a temperature sensing apparatus according to a second embodiment of the present invention.

FIG. 6 shows a temperature sensing apparatus according to a third embodiment of the present invention.

FIG. 7 shows the constant current source shown in FIG. 6.

### DETAILED DESCRIPTION

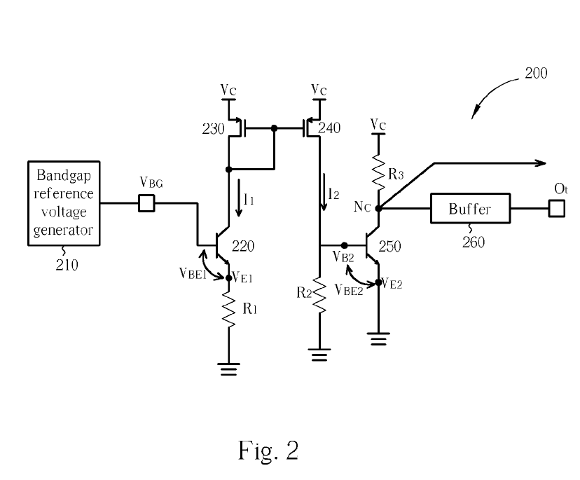

Please refer to FIG. 2. FIG. 2 shows a temperature sensing apparatus according to a first embodiment of the present invention. The temperature sensing apparatus 200 comprises a bandgap reference voltage generator 210 for providing a temperature independent voltage V_{BG}. The bandgap reference voltage generator 210 with low sensitivity to both temperature and supply voltage is commonly required in analog or digital circuits. There are several methods to realize the bandgap reference voltage generator 210. Utilizing the base-emitter junction of a bipolar transistor as a core component of the bandgap reference voltage generator 210 is the most popular approach. The methods of implementing the bandgap reference voltage generator 210 are well known to those skilled in the art so the detailed description of the bandgap reference voltage generator 210 is omitted for brevity.

he temperature independent voltage V_{BG} is applied to a base of a bipolar junction transistor 220. The voltage V_{BE1} shown in FIG. 2 (i.e., the base-to-emitter turn on voltage of the bipolar junction transistor 220) can be expressed according to the following equation:

$${V}_{BE 1} = \frac{k \times T}{q \times ln ( \frac{{I}_{C 1}}{{I}_{S 1}} )} ; \qquad ( 2 )$$

where k represents the Boltzmann's constant, and T represents absolute temperature, utilizing the Kelvin scale. This equation is well known in the art and therefore not explained in detail here. Accordingly, the node voltage V_{E1} at an emitter terminal of the bipolar junction transistor 220 can be derived as follows:

$${V}_{E 1} = {V}_{BG} - {V}_{BE 1} = {V}_{BG} - \frac{k \times T}{q \times ln ( \frac{{I}_{C 1}}{{I}_{S 1}} )} . \qquad ( 3 )$$

In addition, the current I₁ can be written as follows:

$${I}_{1} = \frac{{V}_{E 1}}{{R}_{1}} . \qquad ( 4 )$$

As the two MOSFETs 230 and 240 form a current mirror for mirroring the current I₁ to a current I₂, the current I₂ can be written as follows:

I₂=n×I₁ (5);

where n substantially represents the ratio of the aspect ratio of the MOSFET 240 to the aspect ratio of the MOSFET 230. Therefore, the node voltage V_{B2} can be derived as follows:

$$\begin{matrix}{V}_{B 2} = {I}_{2} \times {R}_{2} \\ = n \times ( {V}_{E 1} / {R}_{1} ) \times {R}_{2} \\ = n \times ( {R}_{2} / {R}_{1} ) \times ( {V}_{BG} - \frac{k \times T}{q \times ln ( \frac{{I}_{C 1}}{{I}_{S 1}} )} ) .\end{matrix} \qquad ( 6 )$$

Please note that the voltage V_{B2} can be well defined by properly choosing the resistance of the resistors R₁ and R₂ and the current mirror multiplier ratio n.

Since voltage V_{BG} is temperature independent, we have

$$\frac{\partial {V}_{B 2}}{\partial T} = \frac{\partial }{\partial T} [ n \times ( {R}_{2} / {R}_{1} ) \times ( - \frac{k \times T}{q \times ln ( \frac{{I}_{C 1}}{{I}_{S 1}} )} ) ] , \qquad ( 7 )$$

and accordingly, by applying some typical values, an approximated equation is further derived as follows:

$$\frac{\partial {V}_{B 2}}{\partial T} \approx ( \frac{{nR}_{2}}{{R}_{1}} ) * 1.5 mV \text{/} \text{K} . \qquad ( 8 )$$

As mentioned, the voltage V_{BG} is temperature independent, however, the voltage V_{E1} is temperature dependent since the characteristics of the bipolar junction transistor 220 is temperature dependent. As a result, the current I₁ and I₂ together with the voltage V_{B2} are all temperature dependent like the relationship shown in equation (8).

In addition to a base terminal receiving the voltage V_{B2} mentioned above, the bipolar junction transistor 250 further has an emitter terminal connected to ground whose voltage level is lower than the base voltage V_{B2}, and a collector terminal coupled to a node N_{C}, which is further coupled to a supply voltage V_{C} through a resistor R₃. The signal at the node N_{c} can be served as the sensing signal for indicating whether the temperature is higher or lower than a threshold, more specifically, a temperature threshold.

It is well known that the base-to-emitter junction (BE junction) turn on voltage of a bipolar junction transistor has a negative temperature coefficient, which is approximately −1.5 mV/K and can be expressed as:

$$\frac{\partial {V}_{BE ( on )}}{\partial T} \approx - 1.5 mV \text{/} K . \qquad ( 9 )$$

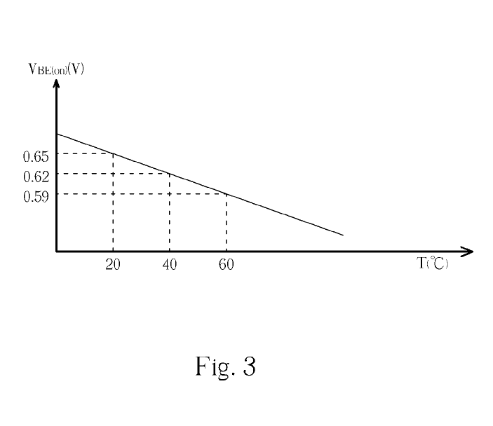

Based on the fact mentioned above, the bipolar junction transistor 250 can be utilized as a temperature sensing device, regardless of whether its base terminal voltage V_{B} is temperature dependent as shown in equation (8) or temperature independent. Bipolar junction transistor 250 can indicate whether the present temperature is higher or lower than the threshold, which is defined by setting a constant voltage difference across the BE junction here. According to this embodiment, assuming that the bipolar junction transistor 250 has the turn on voltage V_{BE(on)} of 0.65V at 20° C., and the voltage difference between the base voltage V_{B2} and the emitter voltage V_{E2} is set to a predetermined value of 0.62V. According to equation (9), the relation of the turn on voltage V_{BE(on)} with respect to the temperature (° C.) is plotted in FIG. 3. As shown in FIG. 3, the turn on voltage V_{BE(on)} decreases as the temperature increases, and the turn on voltage V_{BE(on)} is 0.65V, 0.62V, and 0.59V at 20° C., 40° C., and 60° C., respectively. Focusing on the bipolar junction transistor 250, before the temperature climbs up to 40° C., the turn on voltage V_{BE(on)} of the bipolar junction transistor 250 is still larger than the base-emitter junction voltage V_{BE2} of 0.62V. However, the voltage on the base-emitter junction V_{BE2} is set as 0.62V which is lower than the turn on voltage V_{BE(on)} corresponding to the temperature less than 40° C., so the bipolar junction transistor 250 is off, leading to a relative high voltage level, typically a voltage level closer to the supply voltage V_{C} than to the ground, at the node N_{C}. In other words, a signal with a voltage level higher than another threshold, e.g. a voltage threshold V_{C}/2, at the node can serve as a sensing signal to indicate that the temperature is less than the threshold 40° C. On the other hand, the temperature becomes higher than 40° C., which means that when the turn on voltage V_{BE(on)} corresponding to the temperature becomes less than the predetermined base-emitter junction voltage V_{BE2} of 0.62V, the bipolar junction transistor 250 turns on, leading to a voltage level change from the relative high voltage level to a relative low voltage level, typically a voltage level closer to ground than to the supply voltage V_{C}, at the node N_{C}. In other words, a signal with a voltage level lower than the voltage threshold V_{C}/2 at the node can serve as a sensing signal to indicate that the temperature is higher than the threshold 40° C. A temperature sensing apparatus is therefore realized by utilizing a bipolar junction transistor with a preset temperature-independent base-emitter junction voltage.

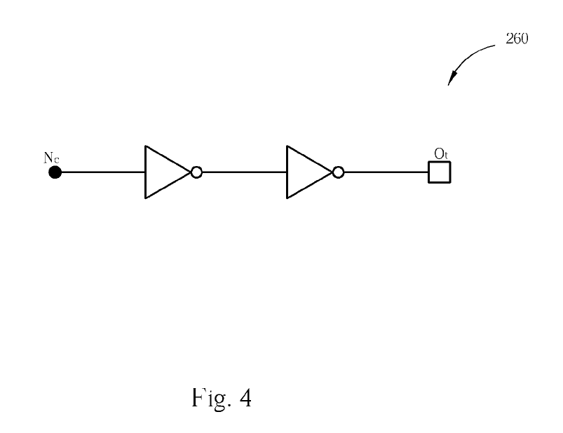

Moreover, since a temperature sensing apparatus is frequently adopted in practical applications such as in a voltage controlled oscillator (VCO), it is required to perform a modification on the original voltage level at the node N_{C} to generate a more definite signal in comparison with the relative voltage levels for indicating the temperature range. Referring to FIG. 2, a buffer 260 is optionally coupled to the node N_{C} for further processing the relative voltage level at the node N_{C}. In this embodiment, the buffer 260 is implemented by utilizing two inverters connected in series as shown in FIG. 4. When the voltage level at the node N_{C} is at a relative low level, the buffer 260 that comprises two inverters turns the relative low voltage level into an absolute low voltage level, e.g., 0V; alternatively, when the voltage level at the node N_{C} is at a relative high level, the buffer 260 turns the relative high voltage level into an absolute high voltage level, e.g., the supply voltage V_{C}. More specifically, when the temperature is lower than the temperature threshold, the buffer 260 outputs a signal of V_{C}; and when the temperature is higher than the temperature threshold, the buffer 260 outputs a signal of 0V. Consequently, the signal at the output terminal Oₜ becomes a digital form having two states (either 0V or supply voltage V_{C}) that can also serve as a sensing signal for indicating whether the temperature is higher or lower than the temperature threshold, which is preset as mentioned. By further adopting the buffer 260, the temperature sensing apparatus 200 becomes more adequate in some practical applications. Please note that in this embodiment the buffer 260 that comprises two inverters merely serves as an example. However, it is apparent and reasonable to take one inverter or any number of inverters connected in series to implement the buffer 260. If inverters totaling an odd number are taken to implement the buffer 260, the buffer 260 outputs a signal of 0V when the temperature is less than the temperature threshold, and outputs a signal of supply voltage V_{C} when the temperature is higher than the temperature threshold.

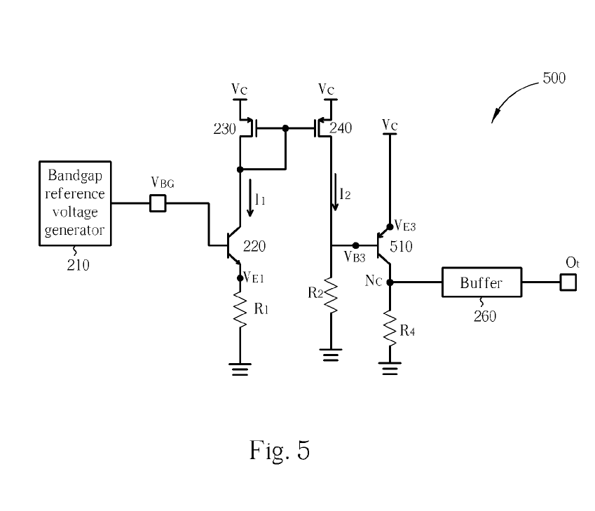

In the first embodiment, the bipolar junction transistor 250 is of the NPN type; however, alternatively, the bipolar junction transistor 250 can be replaced with a bipolar junction transistor of the PNP type. Please refer to FIG. 5. FIG. 5 shows a temperature sensing apparatus 500 according to a second embodiment of the present invention. The circuitry of the second embodiment is almost identical to the circuitry of the first embodiment, except that the NPN bipolar junction transistor 250 is replaced with the PNP bipolar junction transistor 510, and that the circuit configuration of the supply voltage V_{C} and the ground voltage and the resistor R₃ with respect to the NPN bipolar junction transistor 250 is altered accordingly. As shown in FIG. 5, the base terminal of the PNP bipolar junction transistor 510 also receives a constant voltage being the base voltage V_{B3}, which is generated according to the voltage V_{BG} from the bandgap reference voltage generator 210. The emitter terminal of the bipolar junction transistor 510 is connected to the supply voltage V_{C} whose voltage level is higher than the base voltage V_{B3}, and the collector terminal is connected to the node N_{C}, which is further coupled to ground through the resistor R₄. Since the base voltage V_{B3} is constant, the voltage difference V_{EB3} across the BE junction of the PNP bipolar junction transistor 510 is also constant, regardless of the temperature-dependent characteristic thereof. Again, a user can set the voltage difference V_{EB3} to correspond to a temperature threshold. When the temperature is lower than the temperature threshold, the bipolar junction transistor 510 is off such that the signal at the node N_{C} corresponds to a relative low voltage level; when the temperature goes higher than the temperature threshold, the bipolar junction transistor 510 turns on such that the signal at the node N_{C} corresponds to a relative high voltage level.

Similarly, like the temperature sensing apparatus 200 shown in FIG. 2, the temperature sensing apparatus 500 may also optionally comprise the buffer 260 to digitize the signal at the node N_{C} to output signal with absolute voltage level as the sensing signal.

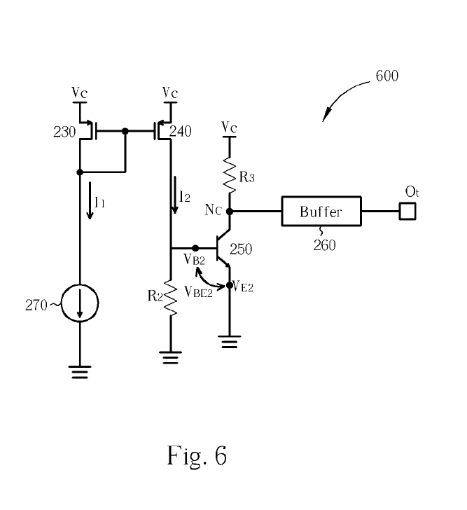

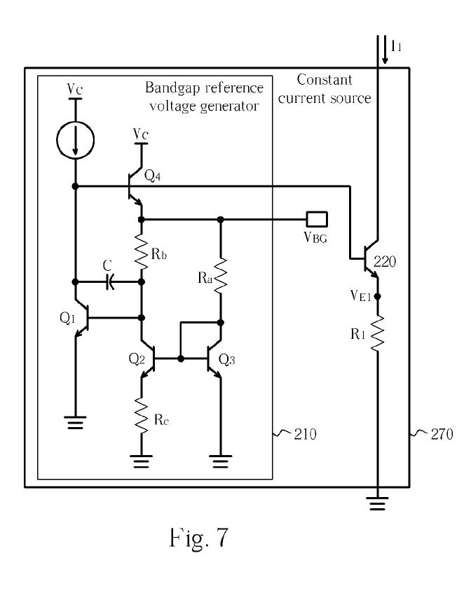

FIG. 6 shows a temperature sensing apparatus 600 according to a third embodiment of the present invention, where the circuitry of a portion of the temperature sensing apparatus 600 is similar to that of a portion of the temperature sensing apparatus 200 mentioned above. As shown in FIG. 6, the temperature sensing apparatus 600 comprises a constant current source 270, which is temperature independent. According to this embodiment, the circuitry of the constant current source 270 is illustrated as shown in FIG. 7, where the gate terminal of the bipolar junction transistor 220 is coupled to a gate terminal of a transistor Q₄ within the bandgap reference voltage generator 210, rather than the node for outputting the voltage V_{BG} mentioned above.

A bipolar junction transistor is utilized as a core device to realize a temperature sensing apparatus. The temperature sensing apparatus outputs at least one sensing signal to indicate whether the temperature is higher or lower than a threshold correspondingly defined by presetting the temperature-dependent voltage difference across the base-emitter junction of the bipolar junction transistor. Plus, a buffer can be further utilized to digitize one sensing signal to generate another sensing signal with a specific voltage level.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A temperature sensing apparatus for generating a sensing signal for indicating whether the temperature is higher or lower than a first threshold, comprising:
a bipolar junction transistor having a base terminal receiving a first constant voltage, an emitter terminal receiving a second constant voltage, and a collector terminal connecting to a node, wherein the second constant voltage is temperature-independent, and the first constant voltage is higher than the second constant voltage; and
a resistor coupled between the node and a supply voltage;
wherein the first threshold is a value corresponding to the difference between the first and second constant voltages, and the signal at the node is outputted to generate the sensing signal, which indicates the temperature is higher than the first threshold if the sensing signal is lower than a second threshold, and indicates the temperature is lower than the first threshold if the sensing signal is higher than the second threshold.

2. The temperature sensing apparatus of claim 1, wherein the bipolar junction transistor is of the NPN type.

3. The temperature sensing apparatus of claim 1, wherein the second constant voltage is ground.

4. The temperature sensing apparatus of claim 1, further comprises:
a buffer coupled to the node for generating a two-state signal as the sensing signal, the two-state signal having a first state for indicating the temperature is higher than the first threshold and a second state for indicating the temperature is lower than the first threshold.

5. The temperature sensing apparatus of claim 4, wherein the buffer comprises at least an inverter.

6. The temperature sensing apparatus of claim 1 further comprising:
a latching device coupled to the node for latching the signal at the node to generate the sensing signal.

7. A temperature sensing apparatus for generating a sensing signal for indicating whether the temperature is higher or lower than a first threshold, comprising:
a bipolar junction transistor having a base terminal receiving a first constant voltage, an emitter terminal receiving a second constant voltage, and a collector terminal connecting to a node, wherein the second constant voltage is temperature-independent, and the second constant voltage is higher than the first constant voltage; and
a resistor coupled between the node and the ground;
wherein the first threshold is a value corresponding to the difference between the first and second constant voltages, and the signal at the node is outputted to generate the sensing signal, which indicates the temperature is higher than the first threshold if the sensing signal is higher than a second threshold, and indicates the temperature is lower than the first threshold if the sensing signal is lower than the second threshold.

8. The temperature sensing apparatus of claim 7, wherein the bipolar junction transistor is of the PNP type.

9. The temperature sensing apparatus of claim 7, wherein the second constant voltage is a constant supply voltage.

10. The temperature sensing apparatus of claim 7, further comprises:
a buffer coupled to the node for generating a two-state signal as the sensing signal, the two-state signal having a first state for indicating the temperature is higher than the first threshold and a second state for indicating the temperature is lower than the first threshold.

11. The temperature sensing apparatus of claim 10, wherein the buffer comprises at least an inverter.

12. The temperature sensing apparatus of claim 7 further comprising:
a latching device coupled to the node for latching the signal at the node to generate the sensing signal.

13. A method for generating a sensing signal for indicating whether the temperature is higher or lower than a first threshold, comprising:
providing a bipolar junction transistor having a base terminal receiving a first constant voltage, an emitter terminal receiving a second constant voltage, and a collector terminal connecting to a node, wherein the second constant voltage is temperature-independent, and the first constant voltage is higher than the second constant voltage; and
providing a resistor coupled between the node and a supply voltage;
wherein the first threshold is a value corresponding to the difference between the first and second constant voltages, and the signal at the node is outputted to generate the sensing signal, which indicates the temperature is higher than the first threshold if the sensing signal is lower than a second threshold, and indicates the temperature is lower than the first threshold if the sensing signal is higher than the second threshold.

14. The method of claim 13, wherein the bipolar junction transistor is of the NPN type.

15. The method of claim 13, wherein the second constant voltage is ground.

16. The method of claim 13 further comprising:
generating a two-state signal as the sensing signal, the two-state signal having a first state for indicating the temperature is higher than the first threshold and a second state for indicating the temperature is lower than the first threshold.

17. The method of claim 13 further comprising:
providing a latching device coupled to the node for latching the signal at the node to generate the sensing signal.

18. A method for generating a sensing signal for indicating whether the temperature is higher or lower than a first threshold, comprising:
providing a bipolar junction transistor having a base terminal receiving a first constant voltage, an emitter terminal receiving a second constant voltage, and a collector terminal connecting to a node, wherein the second constant voltage is temperature-independent, and the second constant voltage is higher than the first constant voltage; and
providing a resistor coupled between the node and ground;
wherein the first threshold is a value corresponding to the difference between the first and second constant voltages, and the signal at the node is outputted to generate the sensing signal, which indicates the temperature is higher than the first threshold if the sensing signal is higher than a second threshold, and indicates the temperature is lower than the first threshold if the sensing signal is lower than the second threshold.

19. The method of claim 18, wherein the bipolar junction transistor is of the PNP type.

20. The method of claim 18, wherein the second constant voltage is a constant supply voltage.

21. The method of claim 18 further comprising:
generating a two-state signal as the sensing signal, the two-state signal having a first state for indicating the temperature is higher than the first threshold and a second state for indicating the temperature is lower than the first threshold.

22. The method of claim 18 further comprising:
providing a latching device for latching the signal at the node to generate the sensing signal.
